(19) United States
(12) Patent Application Publication
(10) Pub. No.: US 2023/0419536 A1
(43) Pub. Date: Dec. 28, 2023

(54) Determination of Changes in Autonomous Vehicle Location Under Adverse Weather Conditions

(71) Applicant: INUITIVE LTD., Ra’anana (IL)

(72) Inventor: Yaakov KAMINITZ, Ramat-Gan (IL)

(21) Appl. No.: 17/850,157

(22) Filed: Jun. 27, 2022

(51) Int. Cl. G06T 7/73; B60W 60/00; B60Q 1/24; G06V 20/56; H04N 5/225; G06T 7/246

(52) U.S. Cl. CPC G06T 7/73; B60W 60/001; B60Q 1/249; G06V 20/588; H04N 5/2256; G06T 7/246; B60R 16/03

(57) ABSTRACT

An apparatus is described that is configured to operate in conjunction with an autonomous vehicle under adverse weather conditions. The apparatus is configured to be installed at the bottom part of the autonomous vehicle, and comprises at least one optical depth sensor and at least one optical projecting module, wherein the at least one optical projecting module is configured to project a light beam being a flood light or a pre-defined pattern onto the road being travelled by the autonomous vehicle, and the at least one optical depth sensor is configured to detect the projection of the light beam onto the road to enable retrieving therefrom information that relates to the movements of the autonomous vehicle along the road being travelled.

### TECHNICAL FIELD

The present disclosure generally relates to the operation of autonomous vehicles, and more particularly, it relates to the operation of autonomous vehicles under adverse weather conditions.

### BACKGROUND

A self-driving car, also known as an autonomous vehicle or autonomous car, is, a ground vehicle capable of sensing its environment and moving safely with no human input.

Self-driving cars combine a variety of sensors to perceive their surroundings, such as cameras, radar, lidar, sonar, GPS, odometry and inertial measurement units. Advanced control system interprets information received from the various sensors to identify appropriate navigation paths, as well as obstacles that are present along the routes being travelled.

Autonomy in vehicles is often categorized in six levels. These levels are the following: Level 0—no automation; Level 1—hands on/shared control; Level 2-hands off; Level 3—eyes off; Level 4—mind off, and Level 5—steering wheel optional.

For the merits of autonomous vehicles to be recognized more extensively, the immediate problem that must be appropriately dealt with, is, the performance of autonomous cars in adverse weather conditions. Weather has various negative influences on traffic and transportation. Averagely, global precipitation occurs 11.0% of the time, and it has been proven that the risk of accident under rain conditions is about 70—higher than normal. In addition, phenomena like snow, fog, haze, and sandstorm severely decrease the visibility and the difficulties they cause for driving, increase substantially.

An inevitable problem for all the current autonomous cars is that they barely operate during heavy rain or snow due to safety issues. Even though lots of research and tests have been conducted in adverse weather conditions, no suitable solutions have yet been found. One of the major reasons for these difficulties is that is hard to detect the exact location and direction of movement of the autonomous vehicle under bad weather conditions, as optical sensors which provide the system with significant information to detect the car's exact location and direction of movement, quite often fail to operate adequately under such weather conditions. Furthermore, under such conditions very often the GPS sensor of the car does not function.

Therefore, the present invention seeks to provide a solution to driving an autonomous vehicle under adverse weather conditions by enabling the autonomous car to be provided with data that will allow the car's system to be constantly updated with the car's direction and location.

### SUMMARY OF THE DISCLOSURE

The disclosure may be summarized by referring to the appended claims.

It is an object of the present disclosure to provide an apparatus configured to provide an autonomous vehicle with constantly updated data related to the vehicle's location.

It is another object of the present disclosure to provide an apparatus configured to retrieve data to enable calculating movements of the autonomous vehicle. Other objects of the present invention will become apparent from the following description.

According to an embodiment of the disclosure, there is provided an apparatus configured to operate in conjunction with an autonomous vehicle, wherein the apparatus is configured to be installed at the bottom part of the autonomous vehicle, wherein the apparatus comprises at least one optical depth sensor and at least one optical projecting module, wherein the at least one optical projecting module is configured to project a beam of light onto the road being travelled by the autonomous vehicle, and wherein the at least one optical depth sensor is configured to detect the projection of the light beam onto the road to enable retrieving therefrom information that relates to the movements of the autonomous vehicle along the road being travelled.

The term “beam of light” as used herein throughout the specification and claims, is used to denote either a flood light or a predefined pattern. Both options are encompassed by the present invention.

In accordance with another embodiment of the disclosure, the at least one optical depth sensor is an image capturing module, configured to capture 3D images of the illuminated road (either by a flood light or by the projected patterns) being projected onto the road. An image capturing module may be a pair of stereoscopic cameras, or a single camera using mono-SLAM (i.e., detecting a 3D trajectory by a monocular camera).

Optionally, a further sensor may be added to the apparatus in order to prevent scale-drift of the acquired image (e.g., an inertial measurement unit (“IMU”))

By yet another embodiment of the disclosure, the apparatus further comprising an electrical connector configured to connect power consuming devices comprised within the apparatus, to a power supply located within the autonomous vehicle.

According to still another embodiment of the disclosure, the apparatus further comprising conveyance means configured to enable conveying the information that relates to the movements of the autonomous vehicle to at least one processor. The at least processor may be located within the apparatus or outside the apparatus, within the autonomous vehicle, or in both, where some of the operations are carried out by a processor located within the apparatus whereas other operations are carried out by a processor located in the autonomous vehicle. The conveyance means may be a cable configured to enable transfer of data or a wireless transmission module such as for example Bluetooth, cellular, Wi-Fi, and the like. All the above-mentioned options, should be understood as being encompassed by the present invention.

In accordance with another embodiment of the disclosure, the apparatus further comprising at least one processor configured to receive the information that relates to the movements of the autonomous vehicle (e.g., captured 3D images) and to determine changes in the autonomous vehicle location that occurred within a pre-defined period of time (e.g., a period of time extending between two of the 3D captured images).

According to another embodiment of the disclosure, the at least one processor is further configured to establish a current location of the autonomous vehicle, based on the determined changes in the autonomous vehicle location.

By still another embodiment of the disclosure, the changes in the autonomous vehicle location are determined based on movement vectors calculated from data retrieved from the information that relates to the movements of the autonomous vehicle (e.g., from the 3D captured images).

### BRIEF DESCRIPTION OF THE DRAWINGS

For a more complete understanding of the present invention, reference is now made to the following detailed description taken in conjunction with the accompanying drawings wherein:

FIG. 1—illustrates a schematic presentation of an autonomous car have an apparatus mounted at the bottom of the autonomous car, construed in accordance with an embodiment of the present invention; and

FIG. 2—illustrates a schematic presentation of an embodiment of apparatus 110 depicted in FIG. 1.

### DETAILED DESCRIPTION

In this disclosure, the term “comprising” is intended to have an open-ended meaning so that when a first element is stated as comprising a second element, the first element may also include one or more other elements that are not necessarily identified or described herein or recited in the claims.

In the following description, for the purposes of explanation, numerous specific details are set forth in order to provide a better understanding of the present invention by way of examples. It should be apparent, however, that the present invention may be practiced without these specific details.

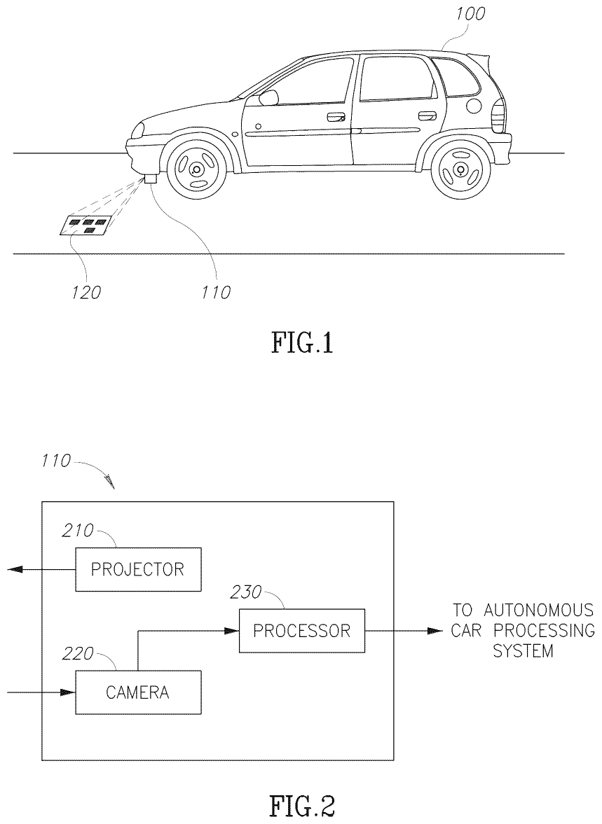

FIG. 1 illustrates a schematic presentation of an autonomous car 100 and an apparatus 110 construed in accordance with an embodiment of the present invention which is configured to enable provisioning of data from which the autonomous car movements can be determined also under adverse weather conditions. Apparatus 110 is mounted/attached to the bottom of autonomous car 100 facing downwardly, so that it is shielded from being exposed to direct precipitations on one hand, but on the other hand it is able to project a light beam (e.g., a pattern) 120 by an optical projector along the road being travelled by autonomous car 100, a pattern which is detected by a 3D camera even under adverse weather conditions. Images of the detected pattern are captured by a 3D camera.

A schematic exploded view of apparatus 110 is presented in FIG. 2. illustrates a schematic presentation of apparatus 100 constructed in accordance with an embodiment of the present invention. Apparatus 110 comprises an optical projector 210 which is located within apparatus 110 so as to ensure that upon attaching apparatus 110 to autonomous car 100, optical projector 210 will be able to project a light beam being a flood light or a pattern (preferably a pre-defined pattern) onto the road which is travelled by autonomous car 100. The pattern is projected by optical projector 210 either continuously or at every predefined period of time (e.g., every few milliseconds). An optical depth sensor, being for example, a 3D camera 220, is positioned within apparatus 110 so that upon attaching 3D camera 220 within apparatus 120, the 3D camera 220 will be capable of capturing a plurality of images of the road being travelled by autonomous car 100, and wherein each image according to this example comprises an instantaneous image of the pattern. The data associated with the images captured by 3D camera 220 are forwarded to processor 230 which is also included according to this example, in apparatus 110. However, it should be noted that there another option of carrying out an embodiment of the invention, by which processor 230 is located away from apparatus 110 (e.g., within autonomous car 100) and the captured images or data associated with the captured images is forwarded to the processor located outside apparatus 110.

The data received by processor 230 is then processed. Following is one example of a method for carrying out such a processing. Once a few frames (images) are obtained, data is retrieved from these frames, and a determination is made as to the data that will be used for analyzing the projected pattern, thereby determining a range of interest for calculating the disparity between pairs of corresponding frames, taken essentially simultaneously, each by a different one of the stereo cameras.

Then, a mapping process is carried out to obtain an initial estimation (studying) of the scene being captured by the 3D camera. There are a number of options to carry out this step, such as applying low resolution to analyze the images or pruning the input data in order to obtain the initial map.

Once the initial map has been acquired and the disparity range of interest has been determined therefrom (i.e., the range where the pattern is included), the disparity range is evaluated (and changed if necessary) on a dynamic basis. In other words, the information retrieved is analyzed and applied in a mechanism which may be considered as one that fine-tunes the low-resolution information. Thus, the disparity value achieved while repeating this step becomes closer to values calculated for the low-resolution disparity in the neighborhood of the pixels being processed.

The results obtained are applied by a stereo matching algorithm that enables determining a depth value for generating a three-dimensional frame from each pair of the stereo frames. Then, from a series of consecutive three-dimensional frames obtained, the movements of the autonomous car are estimated, and its current location is determined. The information obtained by the processor (e.g., the movements made by the autonomous car, its location, etc.) is forwarded to the processing means of the autonomous car itself using a cable that is configured to enable transfer of data or by using a wireless transmission module such as for example Bluetooth, cellular, Wi-Fi, and the like, that is used to forward the above information to the processing system of the autonomous car.

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

The present invention has been described using detailed descriptions of embodiments thereof that are provided by way of example and are not intended to limit the scope of the invention in any way. The described embodiments comprise different objects, not all of which are required in all embodiments of the invention. Some embodiments of the present invention utilize only some of the objects or possible combinations of the objects. Variations of embodiments of the present invention that are described and embodiments of the present invention comprising different combinations of features noted in the described embodiments will occur to persons of the art. The scope of the invention is limited only by the following claims.

1. An apparatus configured to operate in conjunction with an autonomous vehicle, wherein said apparatus is configured to be installed at the bottom part of the autonomous vehicle, wherein said apparatus comprises at least one optical depth sensor and at least one optical projecting module, wherein the at least one optical projecting module is configured to project a light beam onto the road being travelled by the autonomous vehicle, and wherein said at least one optical depth sensor is configured to detect projection of the light beam onto the road to enable retrieving therefrom information that relates to the movements of the autonomous vehicle along the road being travelled.

2. The apparatus of claim 1, wherein said at least one optical depth sensor is an image capturing module, configured to capture 3D images of the illuminated road.

3. The apparatus of claim 1, further comprising an electrical connector configured to connect power consuming devices comprised within the apparatus, to a power supply within the autonomous vehicle.

4. The apparatus of claim 1, further comprising conveyance means configured to enable conveying the information that relates to the movements of the autonomous vehicle to at least one processor for its processing.

5. The apparatus of claim 1, further comprising at least one processor configured to receive the information that relates to the movements of the autonomous vehicle and to determine changes in the autonomous vehicle location that occurred within a pre-defined period of time.

6. The apparatus of claim 5, wherein said at least one processor is further configured to establish a current location of said autonomous vehicle, based on the determined changes in the autonomous vehicle location.

7. The apparatus of claim 5, wherein said changes in the autonomous vehicle location are determined based on movement vectors calculated from data retrieved from said information that relates to the movements of the autonomous vehicle.
